(19) United States
(12) Patent Application Publication
(10) Pub. No.: US 2026/0066567 A1
(43) Pub. Date: Mar. 5, 2026

(54) MALE CONNECTOR STRUCTURE

(71) Applicants: DINKLE ENTERPRISE CO., LTD., New Taipei City (TW); DINKLE ELECTRIC MACHINERY (CHINA) CO., LTD., Kunshan City (CN); LI YANG ELECTRIC MACHINERY (DONGGUAN) CO., LTD., Dong Guan City (CN)

(72) Inventor: Shang-Tsai WU, New Taipei City (TW)

(21) Appl. No.: 18/818,448

(22) Filed: Aug. 28, 2024

(51) Int. Cl. H01R 13/405; H01R 13/05

(52) U.S. Cl. CPC H01R 13/405; H01R 13/055

(57) ABSTRACT

A male connector structure plugs in a female connector and includes a tongue plate and an overlapping assembly. The tongue plate has a first plane and a second plane. The overlapping assembly includes a fixed ferrule and two plate-springs. The fixed ferrule sheathes the tongue plate. Each of the plate-springs is connected to the fixed ferrule, respectively corresponding to the first plane and the second plane, and includes a plurality of elastic arms arched from the fixed ferrule toward a direction away from the tongue plate. When the male connector structure plugs in the female connector, an arch of each of the elastic arms are stuck and fixed to an inner wall of the female connector. The structure and reduce the cost of female connector may be simplified and reduced respectively, and the overlapping assembly may effectively improve the efficiency, stability and service life of current transmission.

### BACKGROUND

### Technical Field

The present disclosure relates to connector field, particularly to a male connector structure.

### Description Of Related Art

There are many types of connectors that are widely used in various fields. Connectors are mainly divided into male connectors and female connectors. Male connectors may make an electrical connection for transmitting power or signals by inserting into the female connector. One type of connector achieves the effects of electrical overlapping and fixing by using a pair of elastic terminals of the female connector to elastically clamp the terminals of the male connector.

However, because the elastic terminal of this type of female connector has complicated structure, the elasticity, conductivity and processability of the material of the elastic terminal shall be considered simultaneously such that the cost and difficulty of manufacturing are high. In addition, due to the high manufacturing difficulty, the number of elastic terminals is limited. Therefore, the amount of overlapping contacts between the elastic terminals of the female connector and the terminals of the male connector is small, so as to affect the efficiency, stability and service life of current transmission.

In view of the above, the inventor seeks to overcome the aforementioned drawbacks associated with the current technology and aims to provide an effective solution through extensive researches along with utilization of academic principles and knowledge.

### SUMMARY

The primary objective of the present disclosure is to simplify the structure and reduce cost of female connector and the overlapping assembly may effectively improve the efficiency, stability and service life of current transmission.

To accomplish the aforementioned objective, the present disclosure provides a male connector structure used to plug and be fixed in a corresponding female connector and having a tongue plate and an overlapping assembly. The tongue plate has a first plane and a second plane configured to be opposite to the first plane. The overlapping assembly includes a fixed ferrule and a pair of plate-springs. The fixed ferrule is fixed to and adapted to sheathe the tongue plate. Each of the plate-springs is connected to the fixed ferrule and respectively configured to be corresponding to the first plane and the second plane. Each of the plate-springs includes a plurality of elastic arms. Each of the elastic arms is arched from the fixed ferrule toward a direction away from the tongue plate. When the male connector structure plugs in the female connector, an arch of each of the elastic arms are stuck and fixed to an inner wall of the female connector

Another aspect of the present disclosure provides that each of the elastic arms is arched to be arc, semicircle or inverted V-shaped.

Another aspect of the present disclosure provides that in each of the elastic arms, the elastic arm includes a connecting section, an arching section, and an abutting section, the connecting section is connected to the fixed ferrule, two ends of the arching section are respectively connected to the connecting section and the abutting section, the abutting section abuts against the corresponding first plane or the corresponding second plane.

Another aspect of the present disclosure provides that the fixed ferrule defines a pair of through slots, the through slots are respectively configured to be corresponding to the first plane and the second plane, each of the plate-springs is located in each of the through slots.

Another aspect of the present disclosure provides that the connecting section extends obliquely from the fixed ferrule toward the tongue plate.

Another aspect of the present disclosure provides that the overlapping assembly further includes a connecting plate, two opposite sides of the connecting plate are respectively connected to each of the abutting section of each of the plate-springs, the connecting plate is located at an end of the tongue plate.

Another aspect of the present disclosure provides that the fixed ferrule defines a buckling hole, the tongue plate has a buckle, the buckle is buckled in the buckling hole.

Another aspect of the present disclosure provides that the fixed ferrule defines a plurality of buckling holes, the tongue plate has a pair of buckles, the buckles are respectively arranged on two opposite sides of the tongue plate and buckled in the buckling holes.

Another aspect of the present disclosure provides that the fixed ferrule includes a first plate, a second plate, a third plate, a first joint plate, and a second joint plate, the first plate and the second plate are configured to be parallel and respectively attached to the first plane and the second plane, the third plate is connected to a same side of the first plate and the second plate, the first joint plate is connected to another side of the first plate and extends toward the second plate, the second joint plate is connected to another side of the second plate and extends toward the first plate, the first t joint plate has a limiting block, the second joint plate defines a positioning groove, the limiting block is fastened in the positioning groove.

Another aspect of the present disclosure provides that the fixed ferrule includes a first plate, a second plate, and a pair of extending plate, the first plate and the second plate are configured to be parallel and respectively attached to the first plane and the second plane, two opposite sides of the first plate respectively has a limiting block extending toward the second plate, the extending plates respectively extends from two opposite sides of the second plate toward the first plate, each of the extending plates defines a positioning groove, each of the limiting blocks is fastened in each of the positioning grooves.

In the male connector structure of the present disclosure, through the overlapping assembly is fixed to and adapted to sheathe tongue plate and each of the plate-springs of the overlapping assembly respectively has a plurality of arched elastic arms, the arch of each of the elastic arms may be stuck and fixed to the inner wall of the female connector to form the overlap when the male connector structure plugs in the female connector. Therefore, the structure and reduce the cost of female connector may be simplified and reduced respectively, and the overlapping assembly may effectively improve the efficiency, stability and service life of current transmission.

### BRIEF DESCRIPTION OF THE DRAWINGS

FIG. 1 is a perspective appearance view in first embodiment of the present disclosure;

FIG. 2 is an exploded view in first embodiment of the present disclosure;

FIG. 3 is a cross-sectional side view in first embodiment of the present disclosure in use;

FIG. 4 is another sectional side view in first embodiment of the present disclosure in use;

FIG. 5 is a perspective appearance view of the second embodiment of the present disclosure;

FIG. 6 is an exploded view in second embodiment of the present disclosure;

FIG. 7 is a cross-sectional side view in second embodiment of the present disclosure in use; and

FIG. 8 is another sectional side view in second embodiment of the present disclosure in use.

### DETAILED DESCRIPTION

It is to be understood that the terms for indicating positions and the location relation, for example “front”, “rear”, “left”, “right”, “front end”, “rear end”, “distal end”, “longitudinal direction”, “lateral direction”, “vertical direction”, “top” and “bottom”, are based on the positions and the location relation disclosed in the drawings, and only used for disclosing the present disclosure and not used for indicating or implying the specified location of the device or the components or the specified structure and operation in certain location, thus the present disclosure is not intended to be limiting.

For example, the terms of “first”, “second”, “third”, “forth” and “fifth” are used for illustrating each unit, component, area, layer and/or part. The component, the unit, the area, the layer and/or the part are not limited by the terms. These terms are only used for separating the element, the assembly, the area, the layer, or the part. Unless being clearly indicated according to the whole specification, the terms for example “the first”, “the second”, “the third”, “the fourth” and “the fifth” are not used for implying the order or sequence.

The technical contents of the present disclosure will become apparent with the detailed description of embodiments and the accompanied drawings as follows. However, it shall be noted that the accompanied drawings are for illustrative purposes only such that they shall not be used to restrict the scope of the present disclosure.

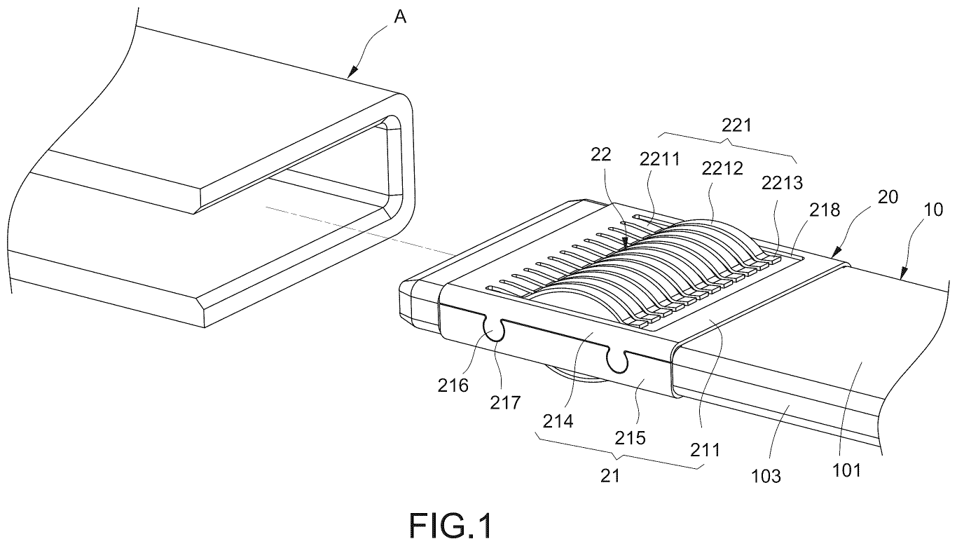

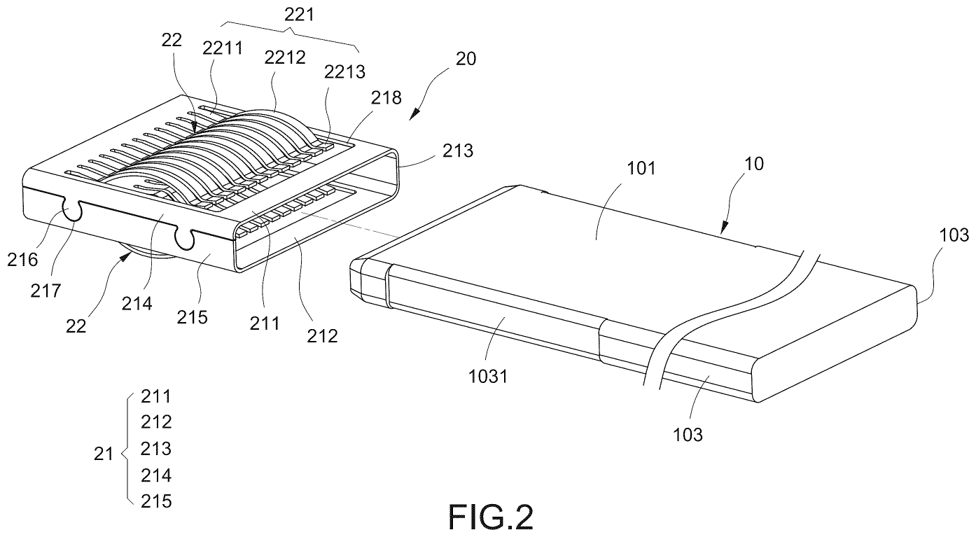

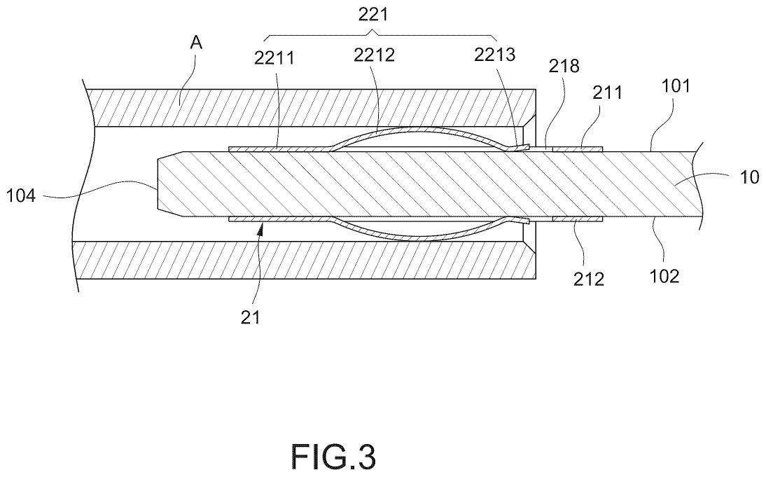

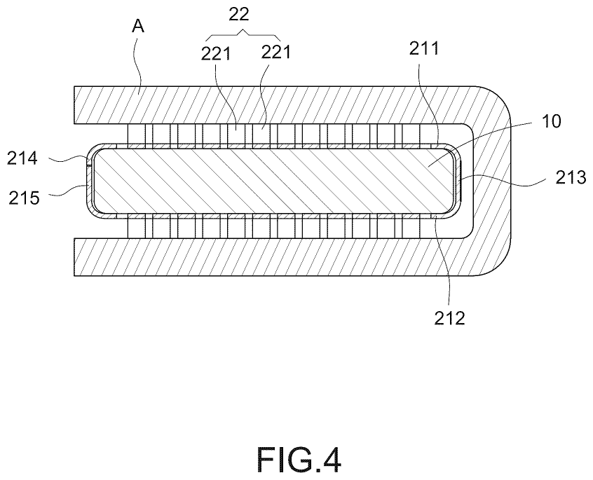

The present disclosure provides a male connector structure, which is used to plug and be fixed in a corresponding female connector A. As shown in FIG. 1, FIG. 2, FIG. 3, and FIG. 4, which show the first embodiment of the male connector structure of the present disclosure. The male connector structure in the first embodiment includes a tongue plate 10 and an overlapping assembly 20.

The tongue plate 10 is made of insulating material. In the first embodiment, the tongue plate 10 is integrally molded by plastic injection in one piece, but the present disclosure is not limited to this embodiment. The tongue plate 10 is a flat plate and has a first plane 101, a second plane 102 configured to be opposite to the first plane 101, two opposite side planes 103, and an end surface 104. Please refer to FIG. 1, FIG. 2, FIG. 3, and FIG. 4 as a reference. In the first embodiment, the first plane 101 is located on a top surface of the tongue plate 10, the second plane 102 is located on a bottom surface of the tongue plate 10, the side planes 103 are respectively located on a left side and a right side of the tongue plate 10, and the end surface 104 is located on a front end of the tongue plate 10, but the present disclosure is not limited to the direction shown in drawings.

The overlapping assembly 20 is made of metal with good electrical conductivity. The overlapping assembly 20 mainly includes a fixed ferrule 21 and a pair of plate-springs 22. The fixed ferrule 21 is fixed to and adapted to sheathe the tongue plate 10. In detail, a fixing groove 1031 is defined on each of the side planes 103 of the tongue plate 10, and two opposite sides (left side and right side) of the fixed ferrule 21 are adapted to sheathe the tongue plate 10 to be fastened and fixed in each of the fixing grooves 1031. In the first embodiment, the fixed ferrule 21 may further be fixed by welding, bonding, or ultrasonic welding after fixing and adapting to sheathe the tongue plate 10, but the present disclosure is not limited to this embodiment. The plate-springs 22 are connected to the fixed ferrule 21, and the plate-springs 22 are respectively configured to be corresponding to the first plane 101 and the second plane 102 to be located on an upper side and a lower side of the tongue plate 10. Each of the plate-springs 22 includes a plurality of elastic arms 221 spaced apart and arranged in parallel. Each of the elastic arms 221 extends from the fixed ferrule 21 and is arched toward a direction away from the tongue plate 10.

Please refer to FIG. 3 and FIG. 4. When the male connector structure plugs in the female connector A, an arch of each of the elastic arms 221 are stuck and fixed to an inner wall of the female connector A such that the male connector structure may achieve electrical connection and effect of fixing and positioning with the female connector A. Therefore, through arranged the overlapping assembly 20 on the male connector structure, the structure and reduce the cost of the female connector A may be simplified and reduced respectively. In addition, due to the ease of manufacturing of the overlapping assembly 20, the number of the elastic arms 221 and the amount of the overlapping contacts between the male connector structure and the female connector A may be significantly increased, so as to effectively improve the efficiency, stability and service life of current transmission.

Details are provided as follows. Each of the elastic arms 221 is arched to be arc, semicircle or inverted V-shaped. In the first embodiment, each of the elastic arms 221 is arched to be arc, but the present disclosure is not limited to this embodiment, the arched shape of each of the elastic arms 221 may be modified and adjusted according to different needs. In detail, each of the elastic arms 221 includes a connecting section 2211, an arching section 2212, and an abutting section 2213. In each of the elastic arms 221, the connecting section 2211 is connected to the fixed ferrule 21, two ends of the arching section 2212 are respectively connected to the connecting section 2211 and the abutting section 2213, and the abutting section 2213 abuts against the corresponding first plane 101 or the corresponding second plane 102. In the first embodiment, the connecting section 2211 extends obliquely from the fixed ferrule 21 toward the tongue plate 10 such that part of the connecting section 2211 abuts against the corresponding first plane 101 or the corresponding second plane 102 and an arched height of the arching section 2212 may be increased, but the present disclosure is not limited to this embodiment. More particularly, each of the elastic arms 221 extends obliquely from the fixed ferrule 21 toward the tongue plate 10 through the connecting section 2211, is arched toward the direction away from the tongue plate 10 through the arching section 2212, and abuts against the corresponding first plane 101 or the corresponding second plane 102 through the abutting section 2213.

Please refer to FIG. 1 FIG. 2, and FIG. 4. The fixed ferrule 21 in the first embodiment includes a first plate 211, a second plate 212, a third plate 213, a first joint plate 214, and a second joint plate 215. The first plate 211 and the second plate 212 are configured to be parallel and respectively attached to the first plane 101 and the second plane 102. The third plate 213 is connected to a same side of the first plate 211 and the second plate 212, that is the third plate 213 is attached to the side plane 103 on right side of the tongue plate 10 in drawings. The first joint plate 214 is connected to another side of the first plate 211 and extends toward the second plate 212, the second joint plate 215 is connected to another side of the second plate 212 and extends toward the first plate 211, that is the first joint plate 214 and the second joint plate 215 are attached to the side plane 103 on left side of the tongue plate 10 in drawings. In detail, the fixed ferrule 21 is bent multiple times (at least four times) to form a sleeve-shaped structure including the first plate 211, the second plate 212, the third plate 213, the first joint plate 214, and the second joint plate 215. The first t joint plate 214 has at least one limiting block 216, the second joint plate 215 defines at least one positioning groove 217. The limiting block 216 is fastened in the positioning groove 217 such that the first joint plate 214 and the second joint plate 215 may position each other without falling apart to maintain the sleeve-shaped structure of the fixed ferrule 21. In the first embodiment, a number of the limiting block 216 and a number of positioning groove 217 are both two, but the present disclosure is not limited to this embodiment.

In addition, the fixed ferrule 21 in the first embodiment defines a pair of through slots 218. The through slots 218 are respectively configured to be corresponding to the first plane 101 and the second plane 102. Each of the plate-springs 22 is respectively located in each of the through slots 218. In the first embodiment, each of the plate-springs 22 is connected to a side of the fixed ferrule 21 adjacent to an end of the tongue plate 10, but the present disclosure is not limited to this embodiment. In detail, in the first embodiment, each of the elastic arms 221 of each of the plate-springs 22 extends obliquely from an edge of the through slots 21 of the fixed ferrule 21 adjacent to the end of the tongue plate 10 toward a center of the through slots 21 and the direction away from the tongue plate 10 (that is each of the elastic arms 221 generally extends in the direction away from the end of the tongue plate 10), and the connecting section 2211, the arching section 2212, and the abutting section 2213 of each of the elastic arms 211 are located in a scope of the through slots 218. A spacing is formed between an end of the abutting section 2213 of each of the elastic arms 211 and the edge of the through slots 21. Therefore, when the male connector structure plugs in the female connector A, the spacing may allow each of the elastic arms 221 to deform without interfering with the fixed ferrule 21.

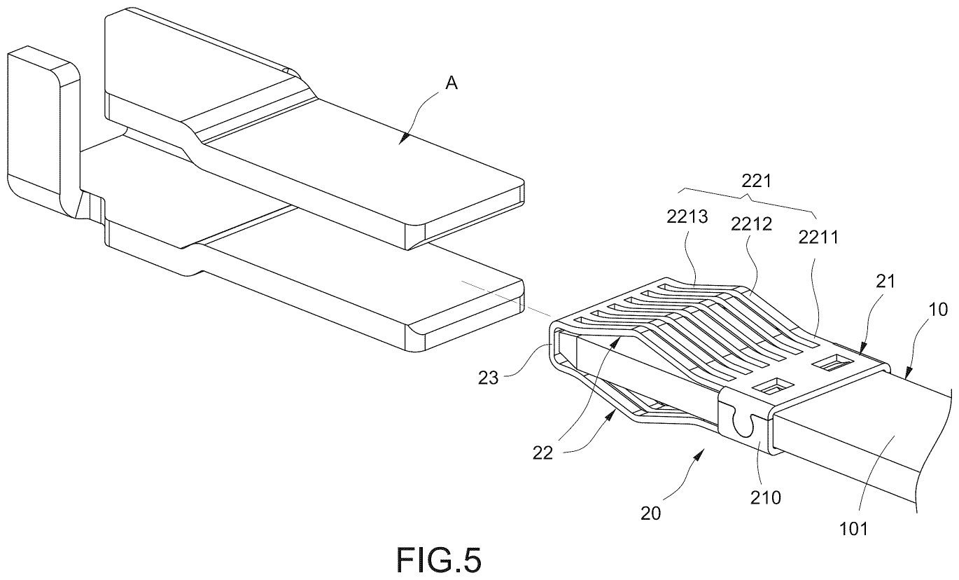

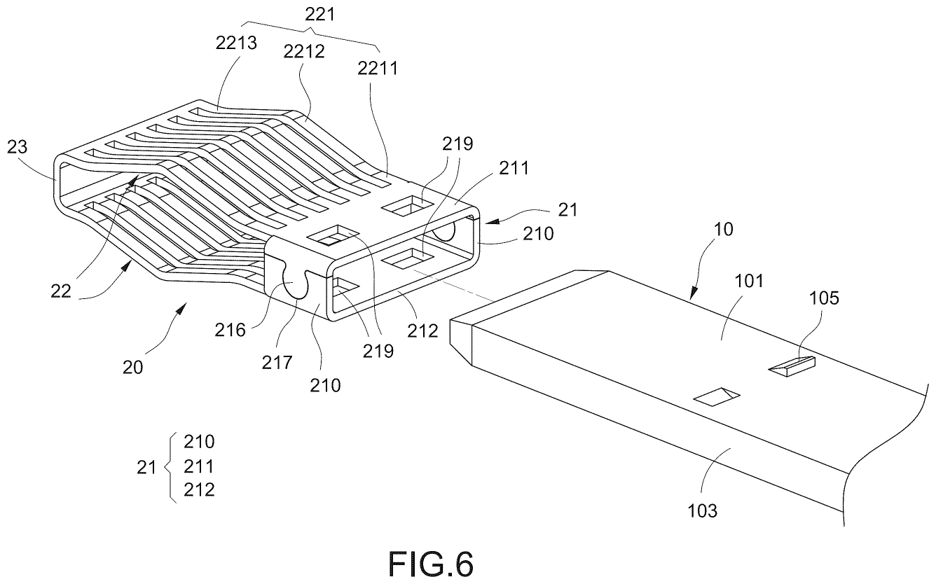

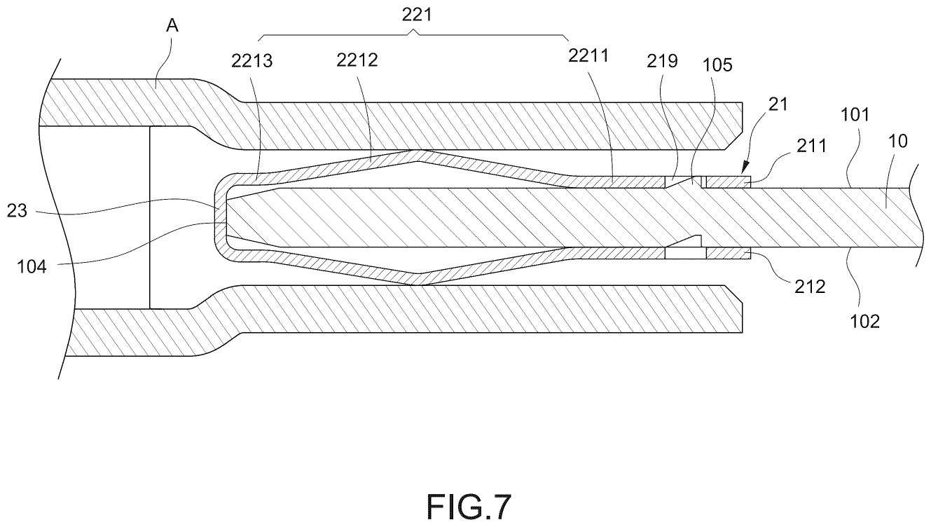

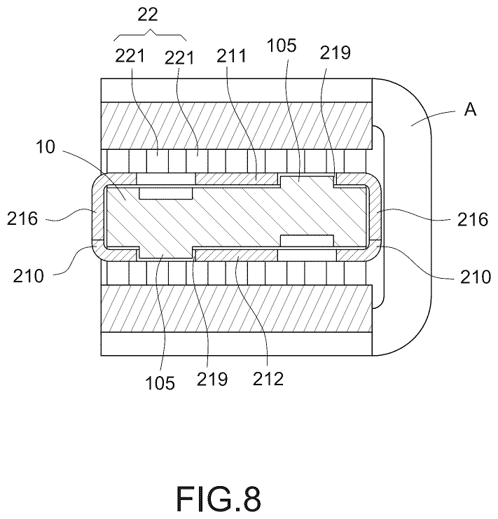

Please refer to FIG. 5, FIG. 6, FIG. 7, and FIG. 8, which show the second embodiment of the male connector structure of the present disclosure. The mainly difference between the second embodiment and the first embodiment is that the structure of the overlapping assembly 20. Details are provided as follows.

In the second embodiment, the overlapping assembly 20 further includes a connecting plate 23, and the fixed ferrule 21 does not define the pair of through slots 218 described in the first embodiment. Two opposite sides (top side and bottom side) of the connecting plate 23 are respectively connected to each of the abutting section 2213 of each of the plate-springs 22 such that the connecting plate 23 is located at the front end of the end surface 104 of the tongue plate 10. Therefore, each of the plate-springs 22 in the second embodiment is connected to the side of the fixed ferrule 21, which is different from each of the plate-springs 22 in the first embodiment that are located in the through slots 218 of the fixed ferrule 21.

The fixed ferrule 21 defines at least one buckling hole 219. The tongue plate 10 has at least one buckle 105. The buckle 105 is buckled in the buckling hole 219, so as to fix the overlapping assembly 20 on the tongue plate 10 without falling apart. In this situation, the second embodiment may omit the technical mean of further fixing the overlapping assembly 20 and the tongue plate 10 through welding, bonding, or ultrasonic welding in the first embodiment, but the second embodiment of the present disclosure does not exclude further strengthening the overlapping assembly 20 and the tongue plate 10 through welding, bonding, or ultrasonic welding. In the second embodiment, the fixed ferrule 21 defines a plurality of buckling holes 219, and the tongue plate 10 has a pair of buckles 105. The buckles 105 are respectively arranged on opposite sides of the tongue plate 10 and buckled in the buckling holes 219 to achieve good buckling effect. In detail, the buckles 105 in the second embodiment are respectively arranged on the first plane 101 and the second plane 102, but the buckles 105 may also be respectively arranged on the side planes 103 in other embodiments.

In the second embodiment, the fixed ferrule 21 includes a first plate 211, a second plate 212, and a pair of extending plate 210. The first plate 211 and the second plate 212 are configured to be parallel and respectively attached to the first plane 101 and the second plane 102. Two opposite sides (left side and right side) of the first plate 211 respectively have a limiting block 216 extending toward the second plate 212. Each of the extending plates 210 respectively extends from two opposite sides (left side and right side) of the second plate 212 toward the first plate 211 to attach each of the side planes 103 of the tongue plate 10. Each of the extending plates 210 defines a positioning groove 217. Each of the limiting blocks 216 is respectively fastened in each of the positioning grooves 217 such that the first plate 211 and each of the extending plates 210 may position each other without falling apart to maintain the sleeve-shaped structure of the fixed ferrule 21. It is worth noting that the fixed ferrule 21 in the second embodiment is different from an integrated connection in the first embodiment. Since the overlapping assembly 20 in the second embodiment is connected to each of the plate-springs 22, the first plate 211, the second plate 212, and each of the extending plates 210 through the connecting plate 23, the fixed ferrule 21 is therefore a sleeve-shaped structure that is assembled up and down.

In the male connector structure of the present disclosure, through the overlapping assembly 20 is fixed to and adapted to sheathe tongue plate 10 and each of the plate-springs 22 of the overlapping assembly 20 respectively has a plurality of arched elastic arms 221, the arch of each of the elastic arms 221 may be stuck and fixed to the inner wall of the female connector A to form the overlap when the male connector structure plugs in the female connector A. Therefore, the structure and reduce the cost of female connector A may be simplified and reduced respectively, and the overlapping assembly 20 may increase the number of elastic arms 221 and the amount of the overlapping contacts between the male connector structure and the female connector A and effectively improve the efficiency, stability and service life of current transmission.

It shall be understood that the present disclosure may have other types of embodiments, and a person with ordinary skills in the art of the technical field of the present disclosure may make various changes and modifications corresponding to the present disclosure without deviating the principle and substance of the present disclosure; however, such corresponding changes and modification shall be considered to be within the claimed scope of the present disclosure.

What is claimed is:

1. A male connector structure, used to plug and be fixed in a corresponding female connector, the male connector structure comprising:
a tongue plate, comprising a first plane and a second plane configured to be opposite to the first plane; and
an overlapping assembly, comprising a fixed ferrule and a pair of plate-springs, the fixed ferrule fixed to and adapted to sheathe the tongue plate, each of the plate-springs connected to the fixed ferrule and respectively configured to be corresponding to the first plane and the second plane, each of the plate-springs comprising a plurality of elastic arms, each of the elastic arms arched from the fixed ferrule toward a direction away from the tongue plate;
wherein when the male connector structure plugs in the female connector, an arch of each of the elastic arms are stuck and fixed to an inner wall of the female connector.

2. The male connector structure according to claim 1, wherein each of the elastic arms is arched to be arc, semicircle or inverted V-shaped.

3. The male connector structure according to claim 1, wherein in each of the elastic arms, the elastic arm comprises a connecting section, an arching section, and an abutting section, the connecting section is connected to the fixed ferrule, two ends of the arching section are respectively connected to the connecting section and the abutting section, the abutting section abuts against the corresponding first plane or the corresponding second plane.

4. The male connector structure according to claim 3, wherein the fixed ferrule comprises a pair of through slots, the through slots are respectively configured to be corresponding to the first plane and the second plane, each of the plate-springs is located in each of the through slots.

5. The male connector structure according to claim 3, wherein the connecting section extends obliquely from the fixed ferrule toward the tongue plate.

6. The male connector structure according to claim 3, wherein the overlapping assembly further comprises a connecting plate, two opposite sides of the connecting plate are respectively connected to each of the abutting section of each of the plate-springs, the connecting plate is located at an end of the tongue plate.

7. The male connector structure according to claim 1, wherein the fixed ferrule comprises a buckling hole, the tongue plate comprises a buckle, the buckle is buckled in the buckling hole.

8. The male connector structure according to claim 1, wherein the fixed ferrule comprises a plurality of buckling holes, the tongue plate comprises a pair of buckles, the buckles are respectively arranged on two opposite sides of the tongue plate and buckled in the buckling holes.

9. The male connector structure according to claim 1, wherein the fixed ferrule comprises a first plate, a second plate, a third plate, a first joint plate, and a second joint plate, the first plate and the second plate are configured to be parallel and respectively attached to the first plane and the second plane, the third plate is connected to a same side of the first plate and the second plate, the first joint plate is connected to another side of the first plate and extends toward the second plate, the second joint plate is connected to another side of the second plate and extends toward the first plate, the first t joint plate comprises a limiting block, the second joint plate comprises a positioning groove, the limiting block is fastened in the positioning groove.

10. The male connector structure according to claim 1, wherein the fixed ferrule comprises a first plate, a second plate, and a pair of extending plate, the first plate and the second plate are configured to be parallel and respectively attached to the first plane and the second plane, two opposite sides of the first plate respectively comprises a limiting block extending toward the second plate, the extending plates respectively extends from two opposite sides of the second plate toward the first plate, each of the extending plates comprises a positioning groove, each of the limiting blocks is fastened in each of the positioning grooves.
